(19) United States
(12) Patent Application Publication
(10) Pub. No.: US 2007/0154622 A1
(43) Pub. Date: Jul. 5, 2007

(54) SURFACE LUBRICATION IN MICROSTRUCTURES

(75) Inventor: Hongqin Shi, San Jose, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/683,034

(22) Filed: Mar. 7, 2007

Related U.S. Application Data
(63) Continuation-in-part of application No. 10/890,352, filed on Jul. 12, 2004.
Application No. 10/890,352 is a continuation-in-part of application No. 10/713,671, filed on Nov. 13, 2003.
(60) Provisional application No. 60/780,292, filed on Mar. 7, 2006.

(51) Int. Cl. B05D 5/12; G02F 1/03

(52) U.S. Cl. 427/58; 359/254

(57) ABSTRACT

Lubricants for lubricating surfaces of microelectromechanical devices are disclosed. Specifically, the lubricants can be applied to the contacting surfaces of the microelectromechanical devices so as to remove stiction of the contacting surfaces.

### CROSS-REFERENCE TO RELATED CASES

This patent application claims priority from co-pending US provisional application Ser. No. 60/780,292 to Hongqin Shi, filed Mar. 7, 2006, the subject matter being incorporated herein by reference in its entirety. This patent application is also a continuation-in-part of co-pending U.S. patent application Ser. No. 10/890,352 filed Jul. 12, 2004, which is a continuation-in-part of U.S. patent application Ser. No. 10/713,671 to Simonian et al, filed Nov. 13, 2003, the subject matter of each being incorporated herein by reference.

### TECHNICAL FIELD OF THE DISCLOSURE

The technical field of the examples to be disclosed in the following sections is related generally to the art of microstructure, and, more particularly, to methods and chemical materials for lubricating surfaces, such as contacting surfaces, of microstructures.

### BACKGROUND OF THE DISCLOSURE

Microstructures, such as microelectromechanical devices (e.g. accelerometers, DC relay and RF switches, optical cross connects and optical switches, microlenses, reflectors and beam splitters, filters, oscillators and antenna system components, variable capacitors and inductors, switched banks of filters, resonant comb-drives and resonant beams, and micromirror arrays for direct view and projection displays) have many applications in basic signal transduction. For example, a spatial light modulator based on a microelectromechanical device steers light in response to electrical or optical signals. Such a modulator can be a part of a communication device or an information display.

A major factor that limits the reliability and widespread use of microelectro-mechanical devices is adhesion. Adhesion is a result of the dominance of surface and interfacial forces, such as capillary, chemical bonding, electrostatic, and van der Waals forces, over mechanical forces which tend to separate microelectromechanical components. When mechanical restoring forces cannot overcome adhesive forces, the microelectromechanical devices are said to suffer from stiction. Stiction failures in contacting microstructures, such as micromirror devices, can occur after the first contacting event (often referred to as initial stiction), or as a result of repeated contacting events (often referred to as in-use stiction). Initial stiction is often associated with surface contamination (e.g., residues of bonding materials or photoresist), or with high energy of contacting surfaces (e.g., clean oxidized silicon or metallic surfaces). For the case of in-use stiction, each time one part of the microstructure (e.g. mirror plate of a micromirror device) touches the other (e.g. stopping mechanism) or the substrate, the contact force grows and ultimately becomes too large for the restoring force to overcome. In this case, the device remains in one state indefinitely. This phenomenon can arise from a variety of underlying mechanisms, such as contact area growth, creation of high-energy surface by micro-wear, surface charge separation etc. An approach to reduce stiction is to lubricate surfaces of microstructures.

### SUMMARY OF THE DISCLOSURE

In view of the foregoing, a method and lubricants for lubricating surfaces, such as contacting surfaces of microstructures are disclosed herein.

In one example, a method for lubricating a microelectro-mechanical device is disclosed. The method comprises: providing a lubricant that comprises a chemical compound to a package for said microelectromechanical device; sealing the package with the microelectromechanical device therein; wherein the lubricant reduces sticking of the microelectromechanical device; and wherein the chemical compound of the lubricant when provided to the package but before lubricating the microelectromechanical device comprises a plurality of silicon atoms.

In another example, a packaged MEMS device is provided, which comprises: a space enclosed and sealed between first and second substrates; a MEMS device within the space; a chemical compound for reducing stiction in the MEMS device, which is a) on a surface of the MEMS device, and b) within said space surrounding said MEMS device but not on a surface of said MEMS device; and wherein the chemical compound comprises a plurality of silicon atoms.

In yet another example, a method comprises: providing a microstructure and a lubricant to an open package; sealing the package; wherein individual molecules of the chemical compound comprise a silicon atom; and wherein the lubricant has a vapor pressure of 0.5 Torr or less at 70° C. or less

In still yet another example, a packaged device comprises: a space enclosed and sealed between first and second substrates; a microstructure disposed within the space; first and second precursors composed of silicon containing molecules; wherein the molecules of the first and second precursors are different; wherein each molecule of the first precursor contains a portion that is chemically bonded to a contacting surface of the microstructure; and wherein each molecule of the second precursor contains a portion that is physisorbed to a layer on the contacting surface.

### BRIEF DESCRIPTION OF DRAWINGS

FIG. 1 is a perspective view of an exemplary microstructure device package having a microstructure device within which a lubricant is disposed;

FIG. 2 is a perspective view of an exemplary micromirror array device comprising array of micromirrors;

FIG. 3 is a perspective view an exemplary micromirror device of the micromirror array device in FIG. 2; and

FIG. 4 schematically illustrates an exemplary lubricant material comprising a disiloxane portion and long fluorocarbon chains.

### DETAILED DESCRIPTION OF SELECTED EXAMPLES

For reducing or eliminating stiction of the contacting surfaces of microstructures, silicon containing lubricants are applied to the microstructures, especially the contacting surfaces of the microstructures.

In one example, the lubricant is a silicon-containing chemical compound. Specifically, each molecule of the chemical compound has one or more silicon atoms. When each molecular comprises multiple silicon atoms, the silicon atoms may form siloxane bonds. The siloxane bonds are preferably attached to fluorinated chains or cyclic azasilanes.

The chemical compounds of the lubricant is preferably liquid in room temperature or lower; and preferably have a low vapor pressure and/or high boiling temperature such that the lubricant does not condense at low temperature such as 70° C. or lower or room temperature or lower, or a high temperature at which the lubricant is stored or at which the microstructure having the target surface is operated. Alternatively, the chemical compound of the lubricant is preferably liquid in a temperature within a range from −30° C. to 70° C., more preferably within the range from −10° C. to 60° C., and more preferably from 20° C. to 50° C.

As one example, the chemical compounds of the lubricant have a vapor pressure of 0.5 Torr or less, 0.25 Torr or less, 0.1 Torr or less, and 0.05 Torr or less at a temperature of 70° C. or lower. At the room temperature or lower the vapor pressure of the lubricant is preferably 2.5×10⁻² Torr or less, 2.5×10⁻² Torr or less, 5×10⁻³ Torr or less, 2.5×10⁻³ Torr or less, 1×10⁻³ Torr or less, 5×10⁻⁴ Torr or less, 2.5×10⁻⁴ Torr or less, or 2×10⁻⁴ Torr or less. On the other hand, the lubricant is desired to be stable at a high temperature, such as up to 200° C. such that the lubricant can still function at high temperatures. The viscosity of the lubricant in liquid phase can be from 1 cP to 100 cP.

At the target surface to be lubricated, molecules of the chemical compound of the lubricant may be physisorbed to the target surface; and more preferably without forming covalent chemical bonds. Moreover, it is desired that the lubricant is capable of forming a physisorbed layer with a thickness of around 3 nm or less at a low partial pressure, and more preferably a monolayer on the target surface.

The surface tension of the lubricant on the target surface is desired to be low, such as 50 dynes/cm or less, or 20 dynes/cm or less. The lubricant may have a high boiling point (e.g. 150° C. or higher, or 200° C. or higher).

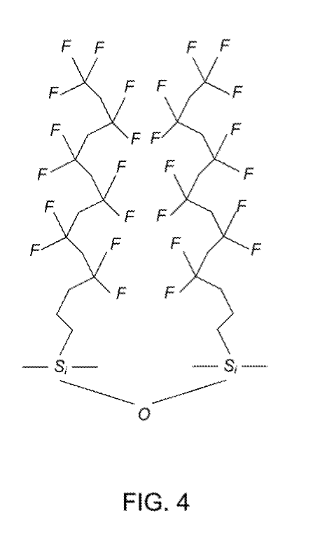

As an example, the chemical compound of the lubricant may comprise a siloxane bond; and more preferably the siloxane bond can be chemically bonded to fluorinated long chain or cyclic azasilanes. Exemplary chemical compounds of the lubricant can be disiloxane with two long fluorocarbon chains, such as Bis (Tridecafluoro-1,1,2,2-Tetrahydoroctyl) Tetramethydisiloxane (C₂₀H₂₀F₂₆OSi₂), N-n-Butyl-Aza-2,2-Dimethoxysilacyclopentane, Bis ((Tridecafluoro-1,1,2,2-Tetrahydoroctyl) Dimethyl-siloxy methysilane (C₂₁H₂₄F₂₆O₂Si₃), and other suitable materials. An exemplary chemical compound having a siloxane bond and two long fluorinate carbon chains is demonstratively illustrated in FIG. 4.

The siloxane bond in the lubricant materials has many advantages. Because siloxane bond is capable of rotating freely along the bond axis, the lubricant can have low melting point such that the lubricant does not crystallize at low temperatures, such as at temperature of −30° C. The partial ionic bond natural of the siloxane bond also enables the lubricant comprised thereof to be strongly physisorbed on the target surface. The chemical compound of the lubricant having a long chain, especially double long chains also has advantages. For example, the long chain(s) may reduce the vapor pressure of the lubricant such that the lubricant can be liquid a low temperature such as 70° C. or less, the room temperature, and even a temperature below zero in Celsius. When multiple long chains are attached to the siloxane bond, the multiple long chains can be inter-bonded—which in turn, stabilizes adsorption of the lubricant chemical compounds on the target surface. Moreover, the long chains attached to the siloxane may exhibit steric shielding effect such that the target surface coated with the lubricant can be more hydrophobic.

The lubricant can be applied to the target surface of the microstructure after the removal of the sacrificial material during the fabrication. Specifically, sacrificial material is deposited in fabrications of the functional members of the microstructure, and is removed afterwards so as to release the microstructure. The released microstructure can be cleaned for example by an energized process, such as plasma and/or ozone, as set forth in U.S. patent application Ser. No. 10/890,352 filed Jul. 12, 2004, and U.S. patent application Ser. No. 10/713,671 filed Nov. 13, 2003, the subject matter of each being incorporated herein by reference in entirety. During or after the cleaning process, the target surface of the microstructure can be dehydrated. The lubricant can then be dispensed in liquid state to the microstructure using a liquid dispenser so as to lubricate the target surface.

In the instance wherein the microstructure is disposed within a space enclosed between a package lid and package substrate of a package, a lubricant container with an opening can be disposed within the package, such as a capillary tubing as set forth in U.S. patent application “Microelectromechanical Devices with Lubricants and Getters Formed Thereon” to Dunphy, Ser. No. 10/810,079, filed Mar. 26, 2004, the subject matter being incorporated herein by reference. The lubricant material can be dispensed into the lubricant container. Through the opening of the lubricant container, the lubricant can arrive at the target surface and fill the space wherein the microstructure is disposed.

The lubricant material can be used along with other chemical materials, such as catalyst or other anti-stiction agents. For example, the target surface of the microstructure can be treated with a self-assembled-monolayer (SAM) material. The SAM material forms a monolayer on the target surface with the molecules of the monolayer being chemisorbed (e.g. forming covalent chemical bonds) or physisorbed to the target surface. On the formed monolayer, the lubricant material can be applied with the chemical compounds of the lubricant physisorbed to the monolayer. The anti-stiction agents each may or may not contain silicon atoms. Exemplary other anti-stiction materials can be: fatty acids (e.g. long-chain n-alkanoic acid), organosilanes, organosulfur compounds (e.g. alkanethiolates, thiophenol, thiocarbamate and mercaptopyridine), alkyl halides, multilayers of organophosphates, perfluoropolyethers or carboxylate perfluoropolyethers, and fluorocarbons. Exemplary organosilanes include alkylhalosilanes, such as chlorotrimethylsilane, alkylalkoxysilanes and alkylaminosilanes. The coating agent can also be a carboxylic acid material having the formula CF₃(CF₂)a(CH₂)_{b}COOH, wherein a is greater than or equal to 0, and b is greater than or equal to 0.

Of course, other suitable lubricant materials are also applicable. For example, the lubricant can be a mono-ether or thio-ether (which can be unfluorinated, partially fluorinated, or perfluorinated), an amine, a phosphine, a borane material, a fluorinated organic material containing a ring structure (e.g. triazines), or a tetralkylsilane having four substituent groups, R₁R₂R₃R₄Si, wherein R₁ to R₄ are bonded to Si and are independently alkyl groups each preferably having 1 to 6 carbons. It is preferred that one of R₁ to R₄ groups is partially or fully fluorinated. The alkyl groups, R₁ to R₄ may or may not be that same, but preferably not labile, e.g. not reactive (e.g. do not hydrolyze). Examples include tetraperfluoroalkylsilanes such as perfluorinated tetramethylsilanes. For example, the lubricant can be a straight-chain fluorocarbon represented by F₃C—(CF₂)ₙ—CF₃, wherein n can be 4,5 (e.g. FC-84, a product from Aka), 6 (e.g. a product from Exfluor), 7 (e.g. a product from Exfluor), and 8 (e.g. a product from Exfluor). As another example, the lubricant can be a perfluoroamine CF₃ (CF₂ₙ)₃N, wherein n can be 3 (i.e. perfluorotributylamine, e.g. FC-43, a product from Aka), 4(e.g. FC-70, a product from Aka), and 5 (i.e. perfluorotrihexylamine, e.g. FC-71, a product from 3M). As yet another example, the lubricant can be a perfluorocarbon with a ring structures, such as perfluorodecalin C₁₀F₁₈ (e.g. a product from Aldrich), perfluoromethyldecalin C₁₁F₂₀ (e.g. a product from Alfa Aesar), perfluoroperhydrophenil C₁₂F₂₂ (e.g. a product from Interchim), perfluoroperhydrofluorene C₁₃F₂₂ (e.g. a product from Interchim), perfluorotetradecahydrophenanthrene C₁₄F₂₄ (e.g. FC-5311, a product from Aka), or perfluorophenanthrene C₁₄F₂₄ (e.g. a product from SciInstrSvcs). As yet another example, the lubricant can be ring-structure perfluorocarbon with one or more oxygen linkage between rings, such as C₁₂F₂₄O, and single cycloether. Alternatively, the lubricant may have fluorocarbon chains attached to a triazine ring, such as C₁₂F₂₁N₃, C₂₄F₄₅N₃ and C₃₀F ₅₇N₃. The lubricant can also be a perfluorinated hydrocarbon having 20 carbons or less, such as alkanes, amines, alcohols, ethers, triazines and glycols.

The lubricant may be mixed with a diluent to form a lubricant solution. The lubricant is desired to be in a liquid phase at room temperature. For example the boiling point of the lubricant can be 30° C. or higher and/or the melting point is 10° C. or lower. The diluent may have a high vapor pressure at room temperature relative to the lubricant such that it does not condense on the target surface. Moreover, it is desired that the diluent is chemically stable at a temperature of 200° C. or higher. An exemplary diluent is a perfluorinated hydrocarbon having 20 carbons or less.

The selected lubricants in this disclosure are useful for lubricate surfaces of many type of materials, such as light reflecting materials for mirror plates (e.g. Al, Ti AlSiCu, and TiAl) and materials for stoppers (e.g. Al, Ir, titanium, titanium nitride, titanium oxide(s), titanium carbide, TiSiNₓ, TaSiNₓ, TiNi, and SiNi or other ternary and higher compounds) that contact with the mirror plate during operation. Other materials for the surfaces may comprise materials that are predominantly intermetallic compounds that are further strengthened by addition of one or more strengthen materials, such as O and N. In this situation, the surface material comprises at least 60 atomic % or more, or 80 atomic % or more, or 90 atomic % or more, or 95 atomic % or more of the intermetallic material. It is further preferred that the intermetallic compound comprises a transition metal, as set forth in U.S. patent applications Ser. No. 10/805,610, filed Mar. 18, 2003; and Ser. No. 10/402,777 filed Mar. 28, 2003, the subject matter of each being incorporated herein by reference.

The lubricant and method of applying the lubricant as discussed above can be applied to varieties of microstructures, especially the microstructures with contacting surfaces. In the following, particular examples wherein the microstructures are micromirror devices will be discussed. It will be understood by those skilled in the art that the following discussion is for demonstration purposes, and should not be interpreted as a limitation. Other variations within the scope of the disclosure are also applicable.

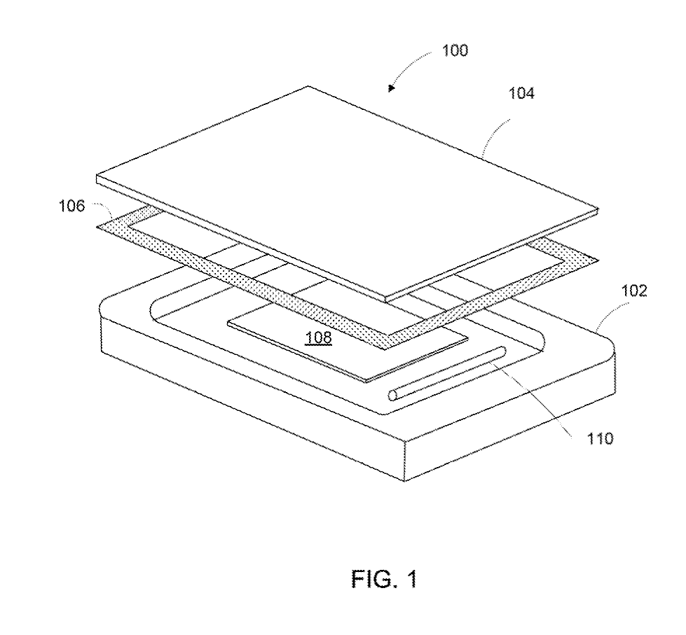

Turning to the drawings, FIG. 1 illustrates a perspective view of an exemplary micromirror device in a package can be implemented. Micromirror device 108 is disposed on a supporting surface of package substrate 102 of package 100. Package lid 104 is bonded to the package substrate via sealing layer 106. The package substrate and the package lid may or may not be hermetically sealed, as set forth in U.S. patent applications Ser. No. 10/852,981 to Tarn, filed May 24, 2004, Ser. No. 10/810,076 to Dunphy, filed Mar. 26, 2004, Ser. No. 10/811,449 to Dunphy filed Mar. 26, 2004; Ser. No. 10/698,656 to Tarn filed Oct. 30, 2003, and Ser. No. 10/443,318 to Tarn field May 22, 2003, the subject matter of each being incorporated herein by reference in entirety.

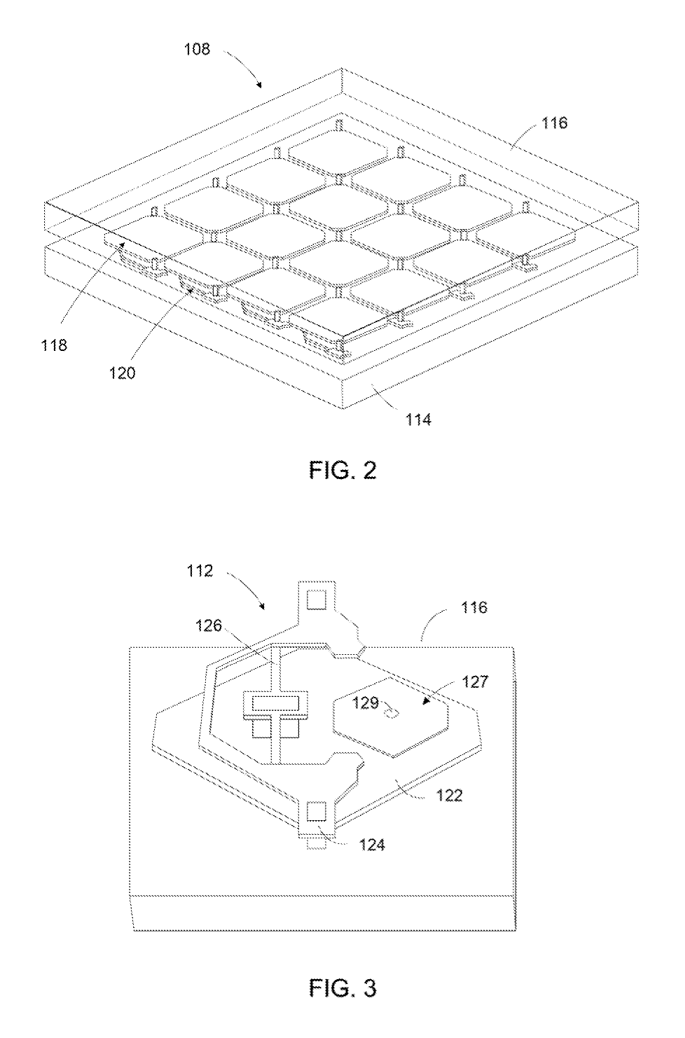

FIG. 2 demonstratively illustrates an exemplary micromirror device 108 in FIG. 1. Referring to FIG. 2, micromirror device 108 comprises an array of reflective deflectable mirror plates 118 formed on substrate 116 which is visible light transmissive. For deflecting the mirror plates, an array of electrodes and circuitry is formed on semiconductor substrate 114. In operation, the mirror plates of the array are individually addressed and deflected by electrostatic fields between the mirror plates and electrodes. The mirror plates reflect incident light onto different spatial directions in accordance with input signals, such as image or video signals so as to display the image.

The micromirrors may take any desired shapes and configurations. A portion of an exemplary micromirror in FIG. 2 is illustrated in FIG. 3. Referring to FIG. 3, the micromirror comprises hinge 126 that is held by two posts 124 on the glass substrate 116. A reflective mirror plate 122 is attached to the hinge such that the mirror plate can rotate relative to the glass substrate in response to the electrostatic field established between the mirror plate and the electrode (not shown) associated with the mirror plate. In this particular example, the mirror plate is attached to the hinge such that the mirror plate can rotate asymmetrically—that is the mirror plate can rotate to a larger angle in one direction than in the opposite direction. This asymmetric rotation is achieved by attaching the mirror plate to the hinge such that the attachment point is neither along a diagonal of the mirror plate nor at the center of the mirror plate. Moreover, the hinge is disposed such that the hinge is parallel to but offset from a diagonal of the mirror plate when viewed from the top. In fact, other configurations can be employed. For example, the mirror plate can be any other desired shape. The hinge and the mirror plate can be arranged such that the mirror plate rotates symmetrically in both directions. As an alternative feature, extension plate 127 can be formed on the mirror plate and connected to the mirror plate via extension post 129. With the extension plate, electrical coupling between the mirror plate and the external electrostatic field can be enhanced, as set forth in US patent application Ser. No. 10/613,379 to Patel, filed Jul. 3, 2003, the subject matter being incorporated herein by reference.

Rather than formed on separate substrates, the micromirrors and electrodes can be formed on the same substrate, such as a semiconductor substrate. In another example, the micromirror substrate can be formed on a transfer substrate that is light transmissive. Specifically, the micromirror plate can be formed on the transfer substrate and then the micromirror substrate along with the transfer substrate is attached to another substrate such as a light transmissive substrate followed by removal of the transfer substrate and patterning of the micromirror substrate to form the micromirror.

The mirror plate of the micromirror device is preferably comprises a reflective layer and a mechanical enhancing layer. As a way of example, the light reflecting layer may be composed of gold, silver, Al, Ti AlSiCu, TiAl, and other suitable materials that exhibit high reflectivity to visible light, such as a reflective of 85% or more, 90% or more, 95% or more, and 98% or more. The mechanical enhancing layer is preferably a ceramic material or other suitable materials, such as Al, Ir, titanium, titanium nitride, titanium oxide(s), titanium carbide, TiSiNₓ, TaSiNₓ, TiNi, and SiNi or other ternary and higher compounds. Other materials for the surfaces may comprise materials that are predominantly intermetallic compounds that are further strengthened by addition of one or more strengthen materials, such as O and N. In this situation, the surface material comprises at least 60 atomic % or more, or 80 atomic % or more, or 90 atomic % or more, or 95 atomic % or more of the intermetallic material. It is further preferred that the intermetallic compound comprises a transition metal, as set forth in U.S. patent applications Ser. No. 10/805,610, filed Mar. 18, 2003; and Ser. No. 10/402,777 filed Mar. 28, 2003, the subject matter of each being incorporated herein by reference.

It will be appreciated by those of skilled in the art that a new and useful method for lubricating microstructure devices in packages has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof. In the claims, only elements denoted by the words “means for” are intended to be interpreted as means plus function claims under 35 U.S.C. § 112, the sixth paragraph.

1. A method for lubricating a microelectromechanical device, comprising:
providing a lubricant that comprises a chemical compound to a package for said microelectromechanical device;
sealing the package with the microelectromechanical device therein;
wherein the lubricant reduces sticking of the microelectromechanical device; and
wherein the chemical compound of the lubricant when provided to the package but before lubricating the microelectromechanical device comprises a plurality of silicon atoms.

2. The method of claim 1, wherein the compound has a vapor pressure of 0.5 Torr or less at a temperature of 70° C. or less.

3-5. (canceled)

6. The method of claim 1, wherein the compound is liquid at a temperature within a range from −30° C. to 70° C.

7-8. (canceled)

9. The method of claim 1, wherein the compound is a siloxane or a disiloxane.

10. (canceled)

11. The method of claim 9, wherein the disiloxane is fully or partially fluorinated.

12. The method of claim 9, wherein the compound comprises Bis-Tetramethydisiloxane, N-n-Butyl-Aza-2,2-Dimethoxysilacyclopentane, Bis (tridecafluoro-1,1 2,2-tetrahydrooctyl) Dimethylsioxy), or cyclic asasilane.

13-15. (canceled)

16. The method of claim 1, wherein the microelectromechanical device is a micromirror comprising a reflective and deflectable mirror plate.

17-20. (canceled)

21. The method of claim 1, wherein the compound forms an anti-stiction coating on surfaces of the microelectromechanical device.

22. The method of claim 1, wherein the package is heated and/or illuminated with light after sealing.

23. (canceled)

24. The method of claim 1, wherein the surfaces of the microelectromechanical device that are in contact with the compound comprise aluminum, a nitride, or oxide of a metal or metalloid.

25. (canceled)

26. A packaged MEMS device, comprising:
a space enclosed and sealed between first and second substrates;
a MEMS device within the space;
a chemical compound for reducing stiction in the MEMS device, which is a) on a surface of the MEMS device, and b) within said space surrounding said MEMS device but not on a surface of said MEMS device; and
wherein the chemical compound comprises a plurality of silicon atoms.

27. The device of claim 26, wherein the MEMS device is a micromirror device comprising a reflective and deflectable mirror plate.

28. The device of claim 26, wherein the compound has a vapor pressure of 0.5 Torr or less at a temperature of 70° C. or less.

29-31. (canceled)

32. The device of claim 26, wherein the compound is liquid at a temperature within a range from −30° to 70°.

33. (canceled)

34. The device of claim 26, wherein the compound comprises a siloxane bond or a disiloxane.

35. (canceled)

36. The device of claim 34, wherein the compound comprises the disiloxane with a fluorocarbon chain, a Bis-Tetramethydisiloxane, a N-n-Butyl-Aza-2,2-Dimethoxysilacyclopentane, a Bis (tridecafluoro-1,1,2,2-tetrahydrooctyl) Dimethylsioxy), or a cyclic asasilane.

37-47. (canceled)

48. The device of claim 26, wherein the compound forms an anti-stiction coating on surfaces of the microelectromechanical device.

49. The device of claim 26, wherein the package is heated and/or illuminated with light after sealing.

50. (canceled)

51. The device of claim 26, wherein the surfaces of the microelectromechanical device that are in contact with the compound comprise aluminum.

52. The device of claim 26, wherein the surfaces of the microelectromechanical device that are in contact with the compound comprise a nitride or oxide of a metal or metalloid.

53-85. (canceled)
